(19) United States
(12) Patent Application Publication
(10) Pub. No.: US 2005/0161468 A1
(43) Pub. Date: Jul. 28, 2005

(54) Tandem piston-type melting unit

(75) Inventor: Uwe Wagner, Gutersloh (DE)

Correspondence Address: BROWDY AND NEIMARK, P.L.L.C.;624 NINTH STREET, NW, SUITE 300, WASHINGTON, DC, 20001-5303, US

(73) Assignee: Delle Vedove Machinenbau GmbH, Schloss Holte-Stukenbrock (DE)

(21) Appl. No.: 11/039,854

(22) Filed: Jan. 24, 2005

(30) Foreign Application Priority Data
Jan. 24, 2004 (DE) 20 2004 001 038.0

(51) Int. Cl. B67D 5/08

(52) U.S. Cl. 222/52; 222/129

(57) ABSTRACT

A piston-type melting unit for melting solid adhesives in an adhesive hopper with a heated grid and for feeding molten adhesive into an adhesive reservoir, has two adhesive hoppers (2, 3), each with one heated grid (22, 32), disposed on the adhesive reservoir (4).

### FIELD OF THE INVENTION

The present invention relates to a piston-type melting unit for melting solid adhesives in adhesive hoppers with heated grids for feeding molten adhesive into an adhesive reservoir.

### BACKGROUND OF INVENTION

In the woodworking industry, veneers, films, or other covering materials are glued onto a carrier material or substrate using a hot-melt adhesive. In such processes, the hot adhesive is continually applied onto the material via a nozzle, rollers, or a blade. The adhesives that are typically used are hot-melt-type adhesives, such as polyurethane resin (PUR), amorphous polyalpha olefins (APAO) or ethylene vinylacetate (EVA), which are supplied in the form of blocks or granules. These adhesives are melted in piston-type melting units and thus liquefied for application.

Piston-type melting units are known, for example the VSK40 by firm DelleVedove, that melt adhesives in an adhesive hopper and feed them to an adhesive applicator unit, such as a roller, nozzle or blade. Piston-type melting units of this type have an adhesive hopper with a volume that is adapted to the commercially available drum sizes. When processing, e.g. PUR adhesive, if there is an extended production interruption or changeover of the production to a different PUR adhesive, the adhesive hopper must be emptied in each case, filled with a cleaning agent, and the system must be flushed with the cleaning agent.

### SUMMARY OF INVENTION

It is an object of the present invention to provide a piston-type melting unit with a larger melting capacity that is adapted for commercially available drum sizes and which avoids, during production changeovers or production interruptions, the emptying of the adhesive hopper in which the adhesive is melted.

This object is met in such a way that the molten adhesive reservoir has provided on it two adhesive hoppers, each one with a heated grid.

### BRIEF DESCRIPTION OF DRAWING

An embodiment of the invention is described in the figures by way of example.

FIG. 1 shows a front view of a tandem piston-type melting unit.

FIG. 2 shows a section through the piston-type melting unit.

FIG. 3 shows a schematic circuit diagram of the control system.

### DETAILED DESCRIPTION OF EMBODIMENTS

By arranging on the adhesive reservoir two adhesive hoppers that each have one grid, four operating modes can be flexibly implemented depending on the production requirement: e.g. sequential operation, parallel operation, alternating operation, and single operation.

During a sequential operation, as soon as all adhesive is melted off in one adhesive hopper, the other adhesive hopper goes into use for melting the adhesive. This significantly extends the time before new solid adhesive needs to be added. During a parallel operation, the adhesive is melted simultaneously in both adhesive hoppers. This makes double the amount of hot-melt adhesive available for processing compared to conventional piston-type melting units.

During an alternating operation, first one adhesive hopper and then the other adhesive hopper is used for melting. This is important particularly for production interruptions and production changeovers. For example, the adhesive may be contained in one adhesive hopper and a cleaning or rinsing material may be contained in the other. During an extended production interruption, a switch is made from the adhesive to the rinsing material. The remaining adhesive can remain in the first adhesive hopper. This is particularly important for PUR adhesive, which easily reacts with moisture in the air and may therefore become unusable during the emptying process. Also, the losses caused by the emptying are minimized.

During a production changeover, if the two adhesives are compatible, the new adhesive is filled into the other adhesive hopper and then switched. Here, too, only a minimal amount of adhesive is lost during the changeover.

For some production processes it is important to make available only a small amount of adhesive. In that case the single operation with only one adhesive hopper is advantageous. The other adhesive hopper can remain clean or be prepared for a different production while the first operation continues.

The amount of melting adhesive is determined by the temperature of the heated grids and exposure time under pressure. The individual control system of each heated grid is used to adjust the quantity from each adhesive hopper. This is particularly important for the alternating operation, where the given heated grid is either turned off or adjusted to the intended temperature for the adhesive or rinsing agent.

Each adhesive hopper becomes particularly easily accessible by means of a fold-down hinge. This facilitates emptying of the adhesive hopper and cleaning of the heated grid.

Likewise, it is advantageous that each heated grid can be folded down via a hinge. This facilitates cleaning of the adhesive reservoir.

Each adhesive hopper has disposed on it a plunger that presses onto the content of the adhesive hopper and applies the content evenly onto the heated grid. A cover also seals the content toward the top to prevent reaction of the adhesive with the air moisture. This plunger is operated through a pneumatic control in such a way that, for melting, the adhesive is pressed onto the heated grid. Once sufficient adhesive is available in the reservoir, the pressure on the plunger is relieved. During production interruptions or for refilling, the plunger is lifted. This ensures that the adhesive in the adhesive hopper is melted only at the lower i.e. exit end. Through the opening of the heated grid the liquid adhesive drips down and is collected in the adhesive reservoir therebelow. In this manner only a small portion of the adhesive contained in the adhesive hopper is melted, which has advantageous effects on the adhesive properties.

The adhesive reservoir is heated in a temperature-controlled manner. The temperature depends on the utilized adhesive in order to maintain the optimum processing temperature.

A fill level indicator in the adhesive reservoir determines the supply of molten adhesive. This is communicated to the control for the heated grids in order to supply only the given required amount of hot-melt adhesive. The hot-melt adhesive is transported via a heated pump and heated line to an adhesive applicator units which are typically rollers, nozzles or blades.

The adhesive reservoir advantageously has dried air supplied to it, which has a pressure dew point of approximately −70° C. This prevents a reaction of a PUR adhesive with air moisture and its adhesive properties are thus maintained even at a low consumption rate.

The control system of the piston-type melting unit regulates the heat output of the heated grids and thus the amount of hot-melt adhesive that is available in the adhesive reservoir.

The control system receives the information regarding the given condition of the piston-type melting unit through sensors. When the adhesive is being melted, pressure, which is also adjusted by the control system, is exerted via the plungers onto the adhesive. A keyboard on the control system is used to set the operating mode of the piston-type melting unit, such as sequential operation, parallel operation, alternating operation or single operation.

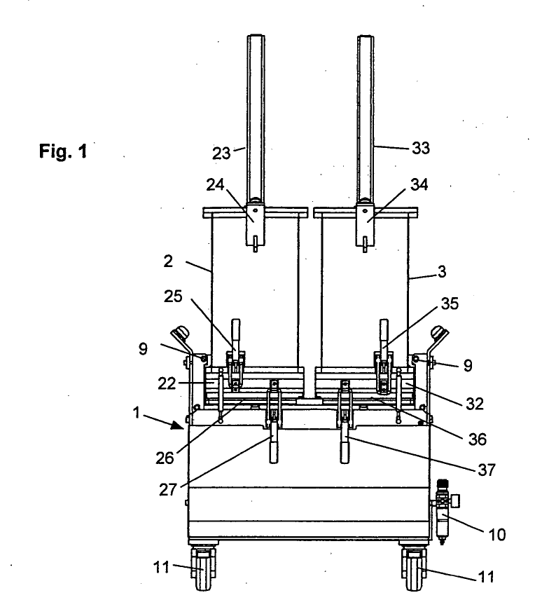

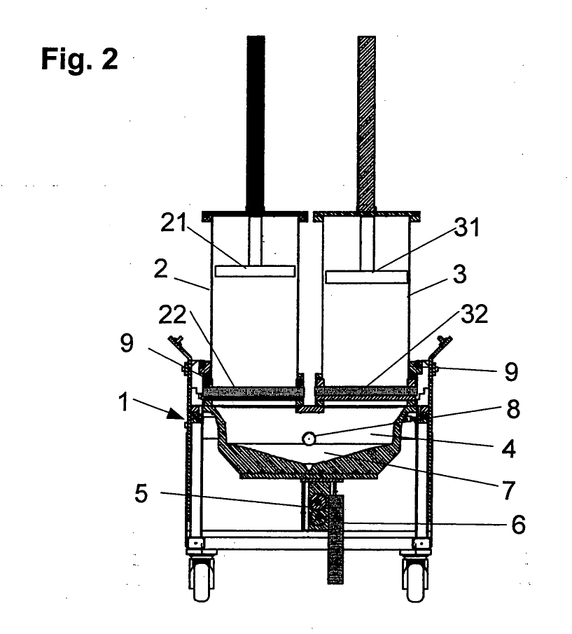

FIG. 1 shows a front view of an embodiment of a piston-type melting unit 1 according to the present invention located on a movable rack with wheels 11. Placed onto the rack are the two adhesive hoppers 2 and 3. Disposed at the lower end of the adhesive hoppers 2 and 3 are the heated grids 22 and 32. Pressing from above are the plungers 23 and 33 (see FIG. 2). Via hinges 24 and 34, the covers of the adhesive hoppers 2 and 3 are openable for refilling of adhesive or cleaning agent.

Each adhesive hopper is pivotably supported about a hinge 9 and closed and locked with the respective closing means 25 and 35. By folding them about these hinges the heated grids 22 and 32 are accessible and can be cleaned. The adhesive hoppers 2 or 3 can also be folded down about the hinges 9 with the respective heated grid 22 or 32 and closed and locked by closing means 27 or 37. This provides access to the adhesive reservoir 4. An air supply inlet 10 supplies the adhesive reservoir 4 with dried air at overpressure, and a reaction of the hot-melt adhesive with the air moisture is thus prevented.

FIG. 2 shows a section through the piston-type melting unit 1. Contained in the adhesive hoppers 2 and 3 is the not yet molten adhesive or alternatively a cleaning agent, onto which pressure is exerted from above with the plungers 21 and 31. The heated grids 22 and 32 melt the adhesive, which drips down into the adhesive reservoir 4 which is heated in a temperature-controlled manner. The fill level of the hot-melt adhesive 7 in the adhesive reservoir 4 is measured with a fill level indicator 8 whereby the heat output of the heated grids 22 and 32 and the pressure of the plungers 21 and 31 is regulated. The hot-melt adhesive 7 is transported through the heated pump 5 and the heated hose 6 to the adhesive applicator unit. The two adhesive hoppers 2 and 3 can be folded down in each case about the hinge 9 which makes the adhesive reservoir 4 accessible for maintenance work.

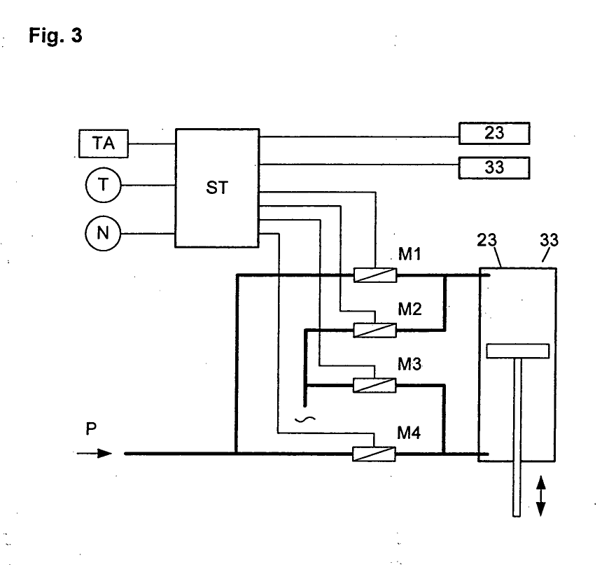

FIG. 3 shows the schematic circuit diagram of the control system ST. Via the temperature sensors T and level indicators N the given conditions are reported to the control system ST. Via the keyboard TA input entries are made for the operation. The control system ST controls the heated grids 22 and 32 in their output and, hence, the available amount of adhesive. The air pressure P is supplied to the plunger 23 or 33 via the magnet valves M1 or M4 into the lower or upper chamber. From the chambers the pressure is released via magnet valves M2 or M3. In this manner the plunger 23 or 33 is adjusted in its elevation and its pressure onto the adhesive via the control system ST.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

1. In a piston-type melting unit for melting solid adhesives in an adhesive hopper with a heated grid and for feeding molten adhesive into an adhesive reservoir, the improvement wherein disposed on said adhesive reservoir (4) are two adhesive hoppers (2, 3), each with one heated grid (22, 32).

2. A piston-type melting unit according to claim 1, wherein each heated grid (22, 32) is operated in its melting capacity by a two-position or more-position regulator.

3. A piston-type melting unit according to claim 1, wherein each adhesive hopper (2, 3) has on the adhesive reservoir (4) a hinge (9) for folding down said hopper.

4. A piston-type melting unit according to claim 3, wherein each said heated grid (22, 32) is foldable about the hinge (9).

5. A piston-type melting unit according to claim 1, wherein each adhesive hopper (2, 3) has an electrically controllable pneumatically actuated plunger (21, 31) for pressing onto the adhesive.

6. A piston-type melting unit according to claim 1, further comprising means for heating the adhesive reservoir (4) in a temperature-controlled manner.

7. A piston-type melting unit according to claim 1, further comprising a fill level indicator (8) in the adhesive reservoir (4) for indicating the supply of molten adhesive (7).

8. A piston-type melting unit according to claim 7, wherein the fill level indicator (8) comprises means for determining the melting output of the heated grids (22,32).

9. A piston-type melting unit according to claim 1, further comprising a heated pump (5) and a heated line (6) for transporting the molten adhesive to an adhesive applicator unit.

10. A piston-type melting unit according to claim 6, further comprising means for supplying dried air to the adhesive reservoir (4).

11. A piston-type melting unit according to claim 10, wherein said means for supplying the dried air provides the dries air at an overpressure.

12. A piston-type melting unit according to claim 5, further comprising means for selectively switching on and off the two heated grids (22, 32) and the pneumatic plungers (23, 33) via a control device (ST), and wherein different operating modes, optionally successive operation, parallel operation, alternating operation and single operation, can be communicated to said control device (ST) via an input device, optionally a keyboard (TA)
